(19) United States
(12) Patent Application Publication
(10) Pub. No.: US 2016/0378310 A1
(43) Pub. Date: Dec. 29, 2016

(54) CONTENT DISPLAY DEVICE AND PROGRAM

(71) Applicant: Sharp Kabushiki Kaisha, Osaka (JP)

(72) Inventors: Satoshi TERADA, Osaka (JP); Hideshi NAKAZAWA, Osaka (JP); Hiroki MUNETOMO, Osaka (JP)

(21) Appl. No.: 15/050,765

(22) Filed: Feb. 23, 2016

(30) Foreign Application Priority Data
Jun. 26, 2015 (JP) 2015-128346

(51) Int. Cl. G06F 3/0484; G06F 3/0482; G06F 3/0488

(52) U.S. Cl. CPC G06F 3/04845; G06F 3/04883; G06F 3/0482; G06F 3/04842; G06F 2203/04803

(57) ABSTRACT

A content display device includes a display control unit for performing a control of displaying a plurality of contents on a display unit, selects one or a plurality of contents from the plurality of contents being displayed and determines an attribute of the selected content. Also, the content display device manages the determined attribute in association with the selected content. When an attribute is selected, the content display device displays the content having the selected attribute in an orderly arranged manner.

This Nonprovisional application claims priority under 35 U.S.C. §119 (a) on Patent Application No. 2015-128346 filed in Japan on 26 Jun. 2015, the entire contents of which are hereby incorporated by reference.

### BACKGROUND OF THE INVENTION

### (1) Field of the Invention

The present invention relates to a content display device and the like.

### (2) Description of the Prior Art

### Background Art

There have been conventionally known techniques of displaying one or a plurality of contents on a display screen in a movable manner using windows or the like.

Since a plurality of windows are displayed, various schemes have been devised in order to provide easy display. For example, Patent Document 1 discloses an invention that comprises: a table that, when windows are classified into a plurality of groups, stores identification information on the windows belonging to each group; a window designating means that designates one desired window from the windows being currently displayed; and a window management means that detects windows belonging to the same group as the window designated by the designating means, by reference to the table based on the identification information that has been previously set for the designated window so as to display the window designated by the window designating means and the windows belonging to the same group, in the front-most layer, by giving priority to them over the windows of other groups (see Patent Document 1, for example).

Patent Document 2 discloses an invention in which windows classified into groups are adapted so that each group of windows can be temporally hidden all at once, re-displayed and iconized, to thereby improve the visibility of the window system using many groups of windows. In the invention of Patent Document 2, the window frames of groups of windows are color-coded, a control panel for group control is further provided so as to improve controllability andvisibility (see Patent Document 2, for example).

### PRIOR ART DOCUMENTS

### Patent Documents

[Patent Document 1]
Japanese Patent Application Laid-open H05-274106

[Patent Document 2]
Japanese Patent Application Laid-open 2001-60134

### OUTLINE OF THE INVENTION

### Problems to be Solved by the Invention

In using a plurality of windows, there is a case where the user wants to display desired windows only. That is, when windows are arranged in order and displayed, usually all the windows are arranged in order and displayed, so that there are poor usability problems.

Further, if a plurality of contents are to be arranged in order, it is considered that a user interface performs selecting the contents to be arranged first and then arranging them orderly. However, this case needs two operation steps, hence is low in usability. Further, when it is performed a process in which desired contents alone are to be orderly arranged, there is a problem that selection of contents to be orderly arranged is troublesome.

### SUMMARY OF THE INVENTION

In view of the above problems, it is therefore an object of the present invention to provide a content display device that can select contents to be arranged in order and perform orderly arranged display and one-stroke operation, based on the attributes associated to individual contents.

### Means for Solving the Problems

In view of the above problems, a content display device of the present invention comprises:

a display unit;

a display control unit configured to perform a control of displaying a plurality of contents on the display unit;

a content selecting unit configured to select at least one content from the plurality of contents being displayed;

an attribute determining unit configured to determine an attribute of the selected content; and,

an attribute managing unit configured to manage the determined attribute in association with the selected content, wherein the display control unit performs a control of displaying the contents that have been displayed on the display unit, in an orderly arranged manner, based on the attribute associated with the content selected by the content selecting unit.

A content display device comprising:

a display unit configured to be able to display a plurality of contents as individual windows;

an attribute selecting unit configured to select a content attribute;

a content selecting unit configured to select a content possessing the selected attribute, from the plurality of contents being displayed; and,

a content orderly arranging unit configured to perform a control of orderly arranging the windows of the selected contents so as to be displayed in parallel.

A content display device of the present invention comprises:

a display unit configured to display a plurality of contents;

a content selecting unit configured to select one or a plurality of contents from the plurality of contents being displayed;

an attribute determining unit configured to determine an attribute of the selected content;

an attribute managing unit configured to manage the determined attribute in association with the selected content; and,

a processing unit configured so that when one attribute is selected from a plurality of attributes set by the attribute determining unit beforehand, a predetermined process is executed on the contents having the selected attribute.

A program of the present invention is a program executed in a computer configured to be able to display a plurality of contents on a display unit, realizing:

a content selecting function of selecting one or a plurality of contents from a plurality of contents being displayed on the display unit;

an attribute determining function of determining an attribute of the selected content;

an attribute management function of managing the determined attribute in association with the selected content;

an attribute selecting function of selecting one attribute from a plurality of attributes determined by the attribute determining function; and,

a display function of displaying contents of the attribute selected by the attribute selecting function in an orderly arranged manner.

### Effect of the Invention

According to the present invention, it is possible to process contents of a selected attribute alone, among multiple contents being displayed. For example, when contents are arranged and displayed orderly, the user can conveniently view desired contents only because the contents possessing the attribute selected by the user alone are aligned and displayed.

Further, the user can assign a desired attribute to any of the contents. This enables the user to select the contents the user desires to handle, so that it is possible to realize a user-friendly content display device or the like.

### BRIEF DESCRIPTION OF THE DRAWINGS

FIG. 1 is an overall appearance view of a first embodiment;

FIG. 2 is a diagram for illustrating the functional configuration of a display device of the first embodiment;

FIG. 3 is a diagram for explaining one example of a data structure of attribute management information in the first embodiment;

FIG. 4 is a chart for illustrating the processing flow in the first embodiment;

FIG. 5 is a chart for illustrating the processing flow in the first embodiment;

FIG. 6 is a diagram for illustrating an operation example in the first embodiment;

FIG. 7 is a diagram for illustrating an operation example in the first embodiment;

FIG. 8 is a diagram for illustrating an operation example in the first embodiment;

FIG. 9 is a diagram for illustrating an operation example in the first embodiment;

FIG. 10 is a diagram for illustrating an operation example in the first embodiment;

FIG. 11 is a diagram for illustrating an operation example in the first embodiment;

FIG. 12 is a chart for illustrating the processing flow in a second embodiment;

FIG. 13 is a diagram for illustrating an operation example in the second embodiment;

FIG. 14 is a chart for illustrating the processing flow in a third embodiment;

FIG. 15 is a diagram for illustrating an operation example in the third embodiment;

FIG. 16 is a diagram for illustrating an operation example in the third embodiment;

FIG. 17 is a chart for illustrating the processing flow in a fourth embodiment;

FIG. 18 is a diagram for illustrating an operation example in the fourth embodiment;

FIG. 19 is a diagram for illustrating an operation example in a fifth embodiment;

FIG. 20 is a diagram for illustrating an operation example in a sixth embodiment;

FIG. 21 is a diagram for illustrating an operation example in a seventh embodiment;

FIG. 22 is a diagram for illustrating an operation example in the seventh embodiment;

FIG. 23 is a diagram for illustrate a configuration of a storage in an eighth embodiment; and,

FIG. 24 is a chart for illustrating the processing flow in the eighth embodiment.

### DESCRIPTION OF THE PREFERRED EMBODIMENTS

Now, the best mode for carrying out the present invention will be described with reference to the drawings. Here, for description convenience, description will be made on exemplary embodiments, but it goes without saying that the invention can be applied to any apparatus as long as is a device that can display contents.

### 1. The First Embodiment

### [1.1 Overall Configuration]

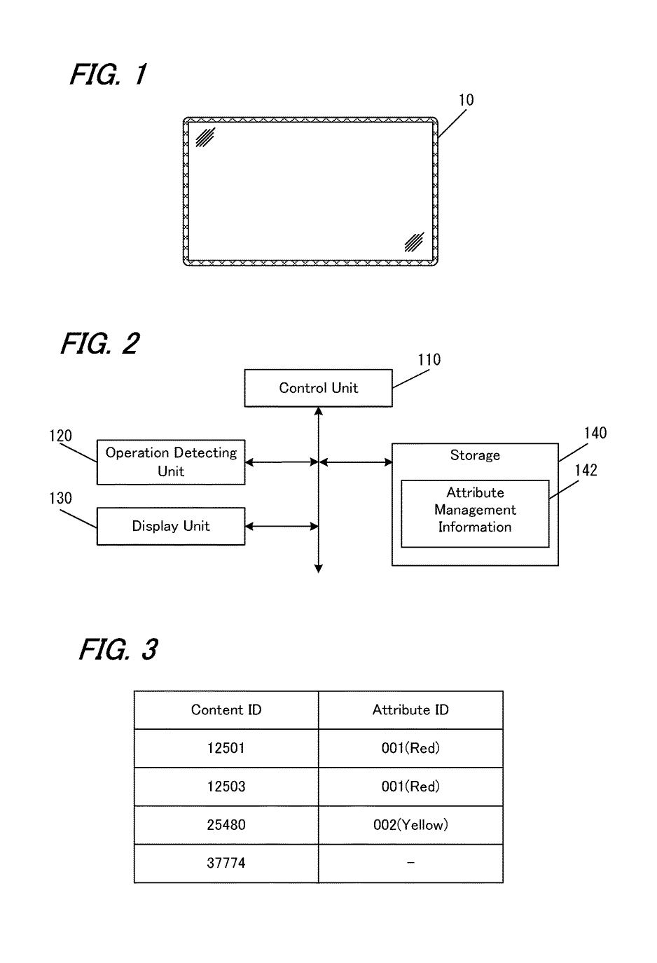

To begin with, FIG. 1 shows the external appearance of a display device 10 to which a content display device of the present invention is applied. The display device 10 is a display device such as a liquid crystal display and is formed with a touch screen that enables input by touching.

In this case, the touch panel can receive an operation input such as touch, flick, slide and others from the user. The method of detecting touch and other input may use a touch panel of a static capacitive type or may use a touch panel of a pressure sensitive type. That is, any device can be used as along as it can correctly receive user's operation input such as touch and the like.

The display device 10 is not limited to, for example, general touch panel displays but may be a device such as a computer, tablet terminal, smartphone, car navigation and the like.

### [1.2 Functional Configuration]

Next, the functional configuration of the display device 10 in the present embodiment will be described with reference to FIG. 2. As shown in FIG. 2, the display device 10 includes a control unit 110, an operation detecting unit 120, a display unit 130 and a storage 140.

The control unit 110 is a functional unit for controlling the whole of the display device 10. The control unit 110 realizes diverse kinds of functions by loading and running various programs stored in the storage 140, and can be configured of, for example, a CPU (Central Processing Unit) and others.

The operation detecting unit 120 is a functional unit for detecting operations from the user. For example, this unit can be configured of a touch panel etc. As the mechanism of detecting operations, any method can be used such as a pressure-sensitive method such as a resistive film method, a static capacitive method, an electromagnetic induction method, an infrared method and others.

The display unit 130 is a functional unit for displaying various pieces of information and contents to the user, and may be comprised of, for example a liquid crystal display (LCD), organic EL display (OELD: organic electroluminescence display) or the like.

The storage 140 is a functional unit for storing necessary various programs and various data for operating the display device 10. The storage 140 can be comprised of, for example, semiconductor memories, HDDs (Hard Disk Drives) and others. The storage 140 stores attribute management information 142.

The attribute management information 142 is information for managing the attribute of each content. FIG. 3 shows one example of the attribute management information 142. The attribute management information 142 records attribute IDs associated with content IDs. For example, an attribute ID “001” is managed in association with a content ID “12501”. Here, “001” represents a state where red is assigned as an aftermentioned color label.

Further, contents are selected from those stored in the storage 140 and displayed on the display unit 130. For this, the coordinates of each content to be displayed on the display unit 130 and the coordinates of the displayable area of the display unit 130 are stored in the storage 140.

Here, in the present embodiment, the display device 10 performs both display and control, but the control may be performed by another device. For example, the control may be performed by a computer that is connected to a display device capable of detecting touch, via USB/HDMI (registered trademark) or the like.

### [1.3 Processing Flow]

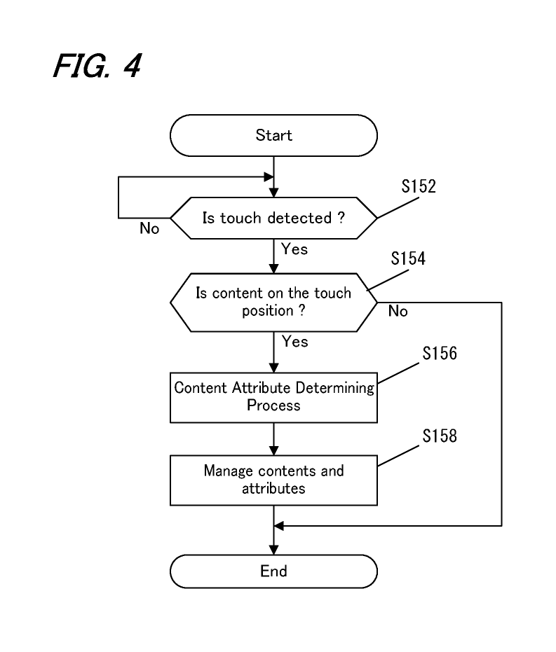

Next, the processing flow in this embodiment will be described referring to the drawings. To begin with, a process of assigning an attribute to each content will be described with reference to FIG. 4.

### [1.3.1 Attribute Assigning Process]

First, in a state that a touch is detected when one or a plurality of contents are being displayed on the display unit 130 (Step S152; Yes), it is determined whether or not there is a content at the touch position (Step S154).

When there is a content (being displayed) at the touch potion (Step S154; Yes), a process (content attribute determining process) of determining the attribute (attribute ID) of the content (content ID) being displayed at the touch position is executed (Step S156). Then, the attribute (attribute ID) is associated with the content (content ID) and stored in attribute management information 142 to thereby manage the content and its attribute (Step S158).

A plurality of methods can be considered for the content attribute determining process. Specific examples will be described below.

### (1) Selection of Color Labels

For example, when the user touches a content on the display unit 130 (or touches and holds a content for a predetermined period of time or longer), a color label selection menu is displayed on the display unit 130. Then, the user selects one color label from a plurality of color labels that are displayed in the color label selection menu as attribute candidates to thereby manage the selected one as the attribute of the touched content.

Herein, it is possible to provide either a configuration in which only one color label can be selected for one content or a configuration in which a plurality of color labels can be selected for one content.

### (2) Selection by Area Dragging

For example, individual areas each associated with an attribute have been previously allocated on the display unit 130, and the user moves a content (by, for example dragging the content with a mouse or the like) to one of the areas to thereby assign the content the attribute being set to the area beforehand.

### (3) Selection by (Gesture) Operation

For example, an operation input on a content may be performed to determine an attribute of the content. For example, individual gestures such as rendering a circle on the content, rendering a triangle, and the like may be set to different attributes. Also, gesture operation of a two-finger touch on the content, three-finger touch on the content and the like may be assigned to different attributes.

### (4) Selection by Free Text Entry

For example, a text input field is made on the display unit 130 to appear as the user touches a content so that the user can fill the text input field with arbitrary characters to thereby set an attribute to the content. For example, text such as “Job”, “Estimate” or the like may be entered so that the same text string is managed as the same attribute. In this case, it is also possible to provide such a configuration that the text string that has been once entered is made to be selectable.

In the above way, various methods can be considered to determine attributes. In the present embodiment herein, the method of selecting color labels will be explained as an attribute determining method.

### [1.3.2 Content Orderly Arranging Process]

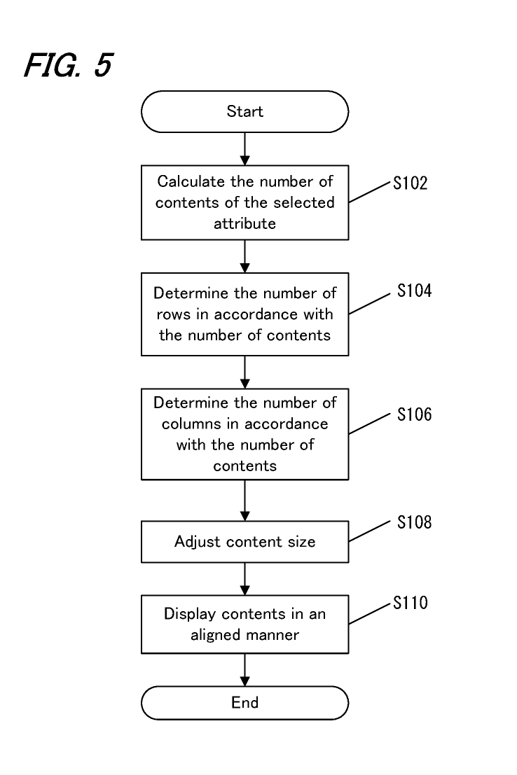

Next, a processing of orderly arranging contents for every attribute will be described with reference to FIG. 5. This process is a process that is executed when the attribute of contents to be arranged in order has been selected. That is, one or a plurality of content attributes are selected from a menu or the like. The attribute that has been selected is referred to as selected attribute.

First, the number of contents of the selected attribute is calculated (Step S102). Specifically, of the contents being currently displayed, the number of contents of the selected attribute is determined from the attribute management information 142.

Next, the number of rows for displaying contents is determined based on the calculated number of contents (Step S104). The number of columns for displaying contents is also determined based on the number of contents (Step S106). To calculate the arrangement of contents, a plurality of methods can be used.

For example, these contents are usually displayed at regular intervals. Accordingly, the arrangement may have been determined beforehand based on the number of contents to be displayed or may be determined by calculation every time.

For example, when one or two contents have the selected attribute, the contents are displayed in one row, whereas when three or four contents are included, the contents are displayed in two rows. When the number of contents increases as five or six, the contents may be displayed in three rows.

Then, the content size is adjusted in accordance with the arrangement (Step S108). That is, this adjustment is performed such that each of the contents to be arranged can secure a maximum area. In this adjustment, as to the content having different lengths in between the horizontal direction and the vertical direction, either one of the lengths may be given priority. For example, when a content has a horizontal-to-vertical ratio of 16:9, it is possible to secure a greater display area of the content by giving priority to the horizontal size.

Then the contents are arranged in order and displayed on the display unit, based on the determined arrangement and the content size (Step S110).

### [1.4 Operation Example]

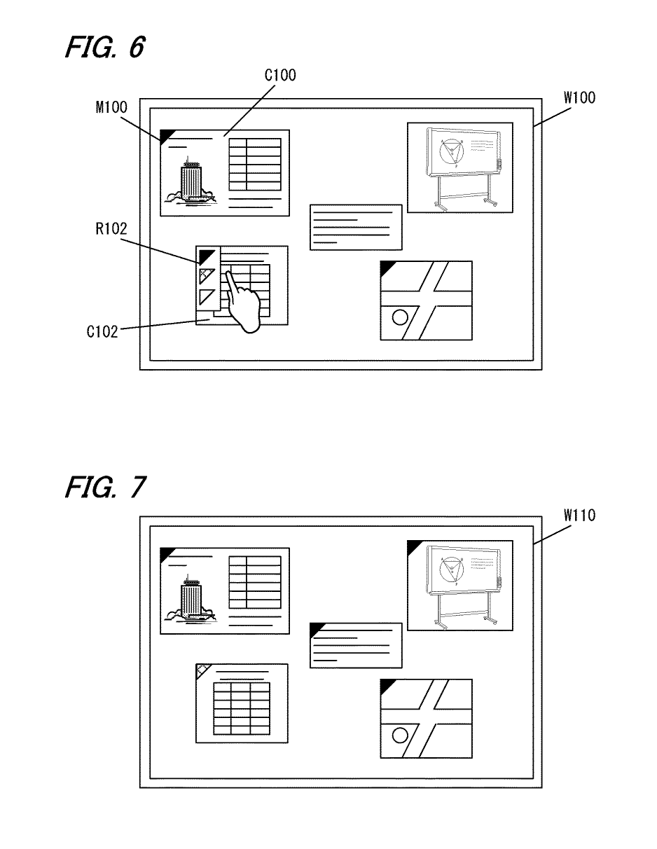

Next, an operation example of the present embodiment will be described with reference to the drawings. FIG. 6 shows an operation example where the user attaches attribute information to contents.

A plurality of contents are displayed on a display screen W100 in FIG. 6. For example, a content C100 is displayed with a color label M100 attached at the upper left corner. For example, in adding an attribute to a content C102, as the user touches the content C102 a color label selection display R102 is displayed in an area R102.

The user selects an arbitrary color label from a plurality of color labels being displayed. As a result, the attribute of the selected color label is recorded in association with the content C102 into the attribute management information 142 (FIG. 2), to thereby manage the attribute of the content C102. When color labels have been selected for all the contents on the display screen W100, the color labels are displayed on all the contents as the display screen W110 in FIG. 7. Here in the present embodiment, all the contents being displayed are attached with a color label. However, it is not necessary for all the contents being displayed to be allotted with a color label.

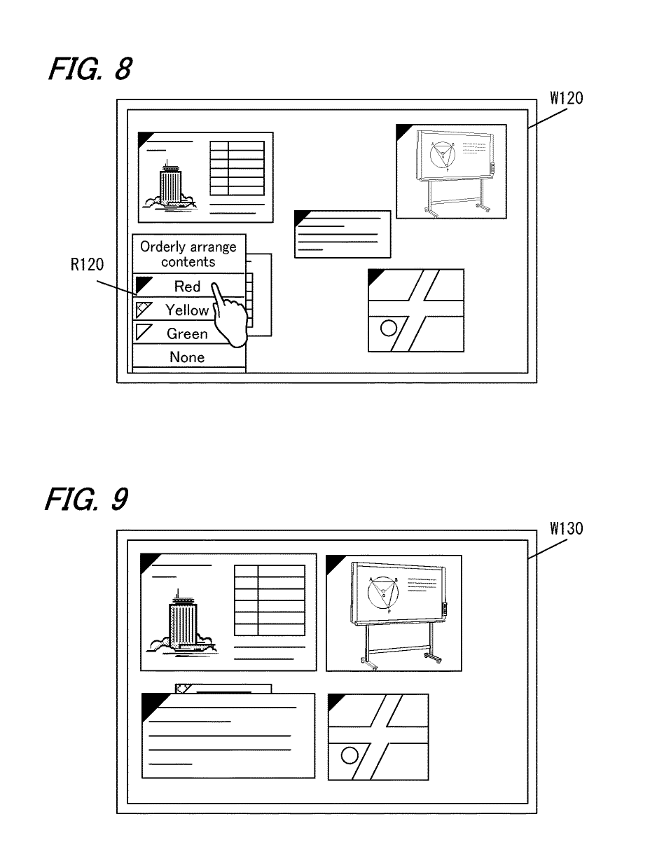

Subsequently, when the user wants to arrange the contents in order, the user calls for a menu display. A display screen W120 in FIG. 8 is a display example in which a contents orderly arranging menu is displayed in an area R120. The user calls for the aligning menu by touching the display screen W120 at the bottom left and selects the attribute of the contents wanted to arrange in order.

A display screen W130 shown in FIG. 9 is a display example when “Red” color label was selected in the state of FIG. 8. In the display screen W130, four contents attached with “Red” color label as the attribution among contents displayed in the display screen W120 in FIG. 8 are displayed in parallel regarding a vertical direction and a horizontal direction on a frontmost layer.

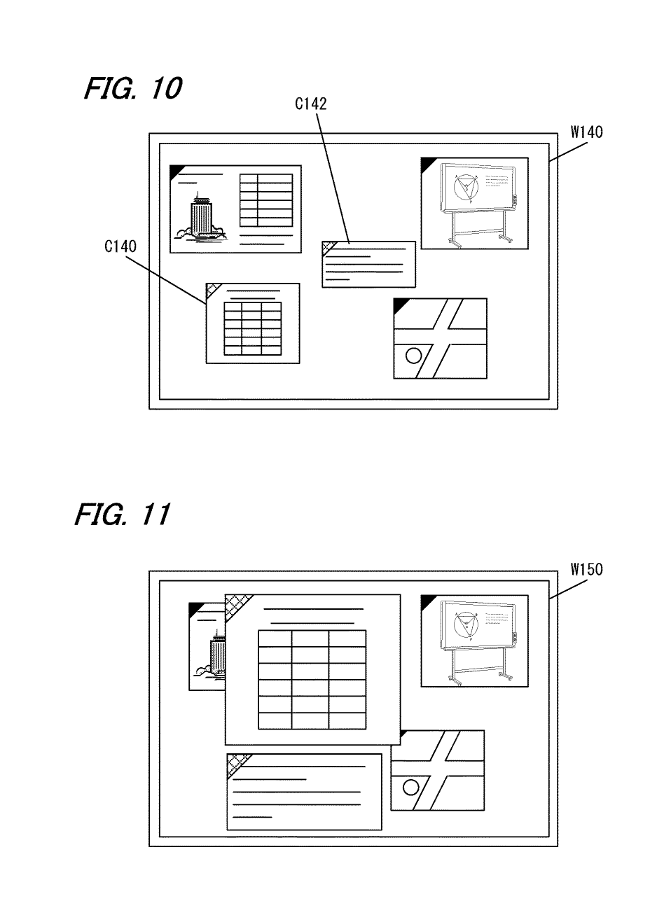

FIG. 10 shows an example where a less number of contents have been selected. Description will be given by taking an example where contents color-labeled with “Yellow” are selected from the display screen W140 and displayed. In the display screen W140, contents C140 and C142 are displayed being attached with “Yellow” color label.

FIG. 11 shows a display screen W150 when yellow is selected as the selected contents in the above state. Since the display screen W150 has two selected contents, the two contents are displayed in one vertical row on the frontmost side.

In this way, according to the present embodiment, it is possible to assign attributes to contents and easily arrange in order and display contents based on the attached attribute. Further, the arrangement of the contents can change in accordance with the number of contents to be arranged in order and displayed, it is possible to arrange in order and display contents in a suitable size.

### 2. The Second Embodiment

Next, the second embodiment will be described. The second embodiment is an embodiment in which contents other than those of the selected attribute are minimized and displayed on the display unit 130.

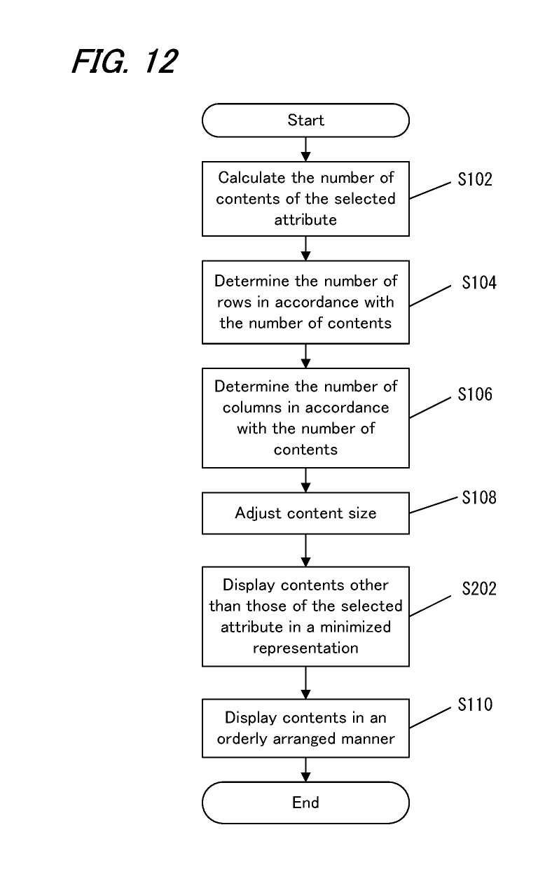

Herein, this embodiment has the same functional configuration as the first embodiment, and uses a processing flow shown in FIG. 12 instead of the processing flow of FIG. 5. Accordingly, the same steps as those in the processing flow of FIG. 5 are allotted with the same reference numerals and description of them is omitted.

As shown in FIG. 12, after the content size of the selected attribute is adjusted, the contents other than those of the selected attribute are minimized and displayed (Step S202). Here, it is also possible to perform minimized display after the contents have been arranged in order and displayed (after Step S110).

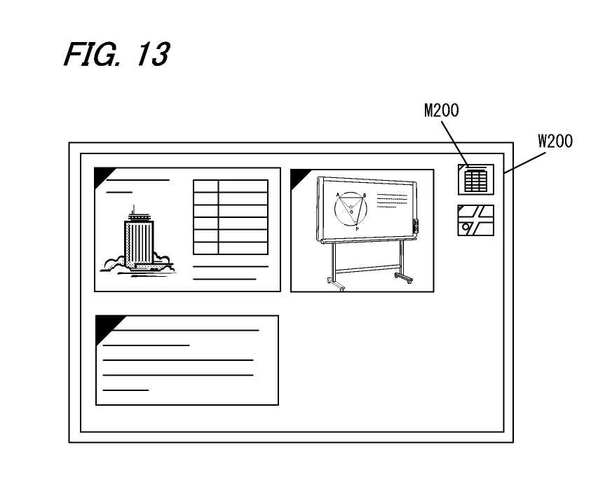

FIG. 13 shows one example of a display screen W200 in this embodiment. In the display screen W200, while three contents of the selected attribute are displayed so that the user can view all at once, the two contents other than those of the selected attribute are displayed as minimized representation M200.

### 3. The Third Embodiment

Next, the third embodiment will be described. The third embodiment is an embodiment in which the content size is altered depending on the content.

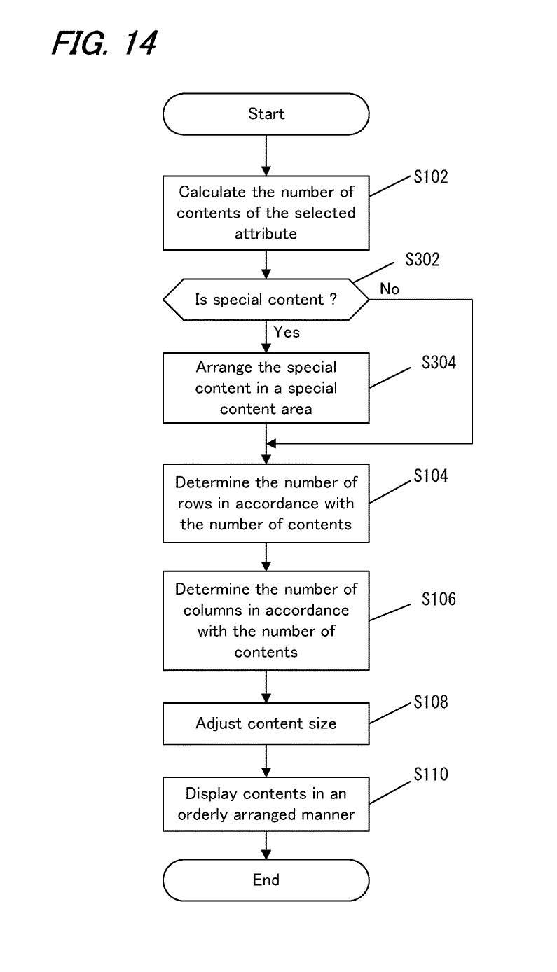

Herein, this embodiment has the same functional configuration was the first embodiment, and uses a processing flow shown in FIG. 14 instead of the processing flow of FIG. 5. Accordingly, the same steps as those in the processing flow of FIG. 5 are allotted with the same reference numerals and description of them is omitted.

When one or a plurality of attributes are selected, it is determined whether or not the selected contents include a special content that is assigned with a special attribute (Step S302). If there is no special content (Step S302; No), the process at and after Step S104 is executed. That is, the same process as in the first embodiment is executed.

The special content may be a content having an attribute that is assigned separately from the attribute that is given to the content, or maybe a content assigned with a predetermined attribute. For example, when “Green” color label has been determined to be assigned as a “special contents” beforehand, if a certain content is wanted to be displayed as a special content, “Green” color label may be selected and assigned to the content.

It is also possible to define an attribute that the selected content originally has, as the attribute for special contents. For example, if the attribute of a content selected as a special content has the attribute of “image file”, it is possible to have contents of “image file” alone handled as special contents.

When it is determined at Step S302 (FIG. 14) that the special content is included (Step S302; Yes), the special content is displayed in a special content area (Step S304).

Then, the special content is processed together with the contents associated with the selected attribute other than “image file”, at and after Step S104.

Here, the special content area may be one area on the display screen of the display unit 130, or a display area of a separately connected display device.

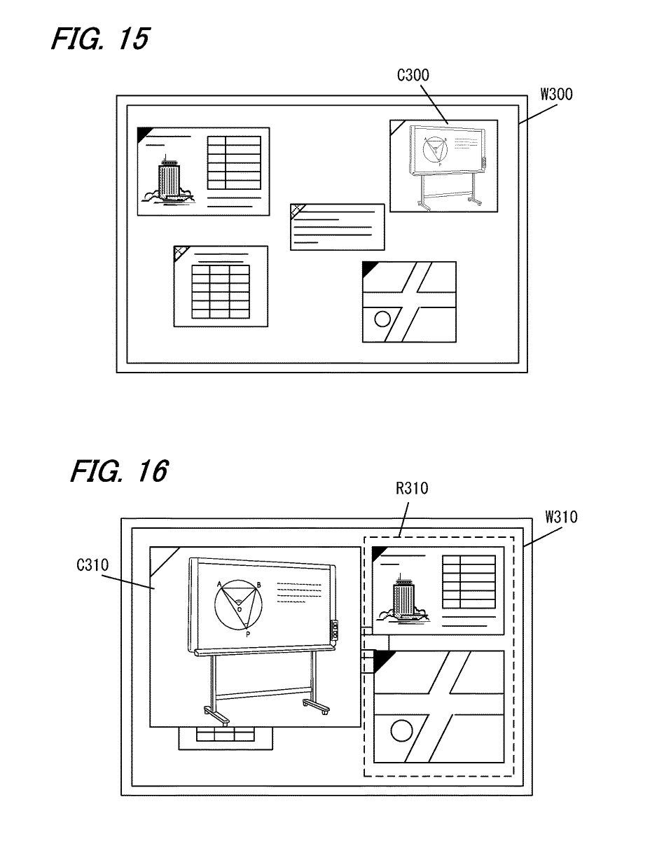

An operation example of the present embodiment will be described. First, as shown in a display screen W300 in FIG. 15, a content C300 is assigned with a special attribute as a special content. This special attribute may be given as one attribute, or given as an extra attribute in addition to the ordinary attribute.

FIG. 16 shows one example in which contents are arranged in order and displayed on a display screen W310. A special content C310 is displayed to be greater than the other selected contents. The other contents of the selected attribute are displayed in an area R310.

Though in FIG. 16 the special content is displayed to be larger in a separate area, the special content may be displayed, for example in the center of the screen over the other contents of the selected attribute, or may be displayed in a switchable manner

### 4. The Fourth Embodiment

Next, the fourth embodiment will be described. The fourth embodiment is an embodiment which gives a warning display when there are too many contents that possess the selected attribute.

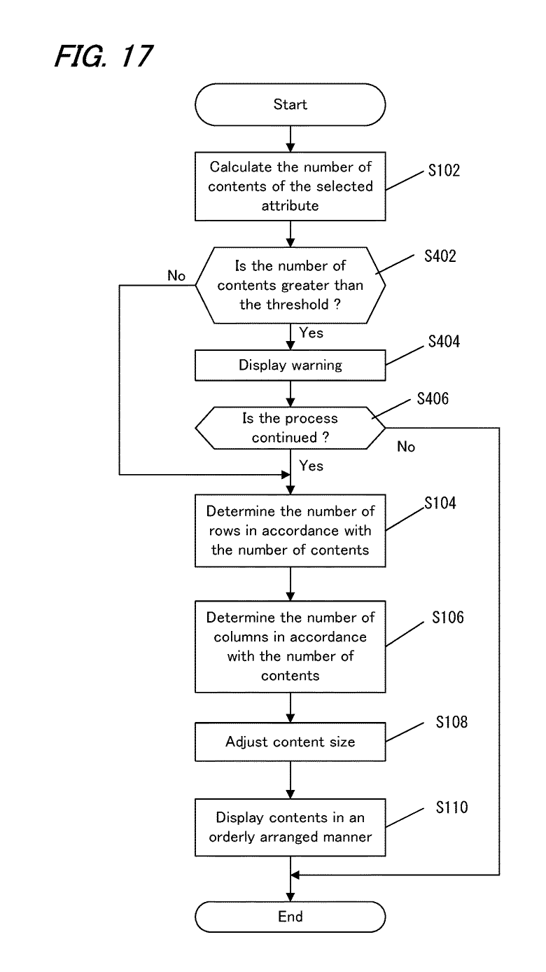

Herein, this embodiment has the same functional configuration with the first embodiment, and uses a processing flow shown in FIG. 17 instead of the processing flow of FIG. 5. Accordingly, the same steps as those in the processing flow of FIG. 5 are allotted with the same reference numerals and description of them is omitted.

At the state where the number of contents possessing the selected attribute has been calculated, it is determined whether or not the number of contents is greater than a threshold (Step S402). When the number of contents is not greater than the threshold, namely when it is determined that the contents are properly displayable, the process at and after Step S104 is executed so that the same process as in the first embodiment is executed (Step S402; No→Step S104).

At this stage, when the calculated number of contents exceeds the threshold (Step S402; Yes), a warning is displayed on the display unit 130 (Step S404). With this warning display, the system inquires the user the confirmation of whether or not the orderly arrangement display should continue.

When the user selects continuation of the process (Step S406; Yes), the process is continued as it is. On the other hand, when the user selects cancellation of the process, this process is ended without performing any orderly arrangement display.

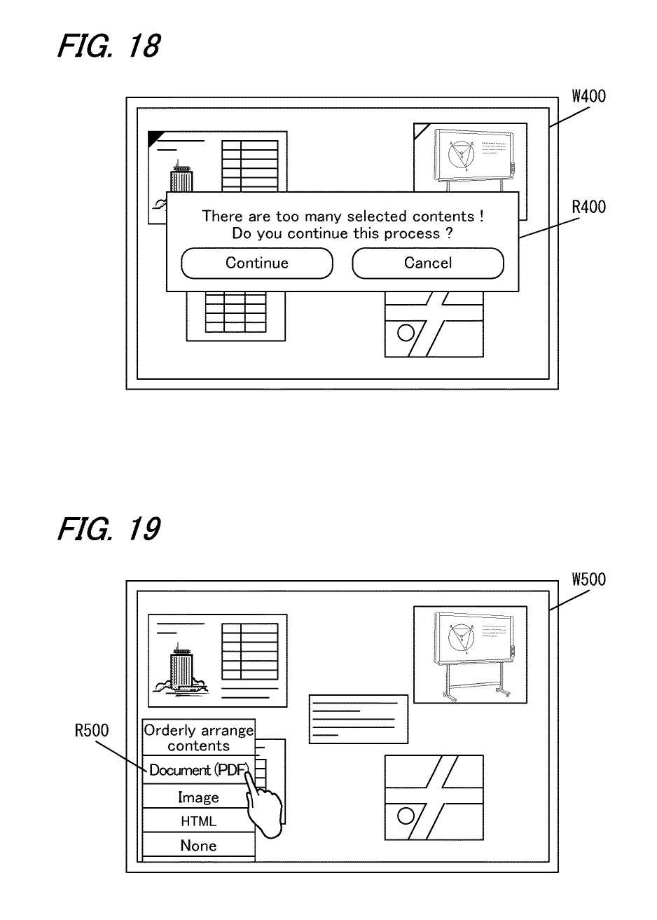

FIG. 18 shows a display screen W400 as an example to explain the operation of this embodiment. In the display screen W400, a warning is displayed in an area R400. Specifically, a confirmation message “There are too many selected contents! Do you continue this process?” is displayed together with select buttons, i.e., “Continue” and “Cancel”. When “Continue” is selected by the user, the contents are arranged in order and displayed. When “Cancel” is selected, no orderly arrangement of contents is performed and the display returns to the previous state. Though this example gives a configuration in which the display returns to the previous state when canceled, it is also possible to provide a configuration in which as many number of contents as the threshold value are displayed.

Furthermore, when the number of contents exceeds the expected number (threshold), it is possible to display a user interface (UI) for selecting contents to be orderly arranged to allow the user to make choice.

### 5. The Fifth Embodiment

Next, the fifth embodiment will be described. The fifth embodiment is an embodiment in which orderly arrangement is performed by using the attributes that are originally possessed by each content or associated with the type of each content.

This embodiment is almost the same as the first embodiment as to the functional configuration and process. In the first embodiment, attribute IDs based on color labels selected by the user are stored as the attribute management information 142. The present embodiment makes use of the attribute each content originally possesses (inherent attribute). For example, displayed contents have inherent attributes such as text (PDF), image, HTML (Hyper Text Markup Language), created date and the like.

User' s selection of this inherent attribute enables easy orderly arrangement of contents. FIG. 19 shows a display screen W500 as an example to explain the operation of this embodiment.

As the user touches the bottom left of the display screen W500, an orderly arranging menu R500 is called. This orderly arranging menu shows inherent attributes that contents have natively possessed, such as “Document (PDF)”, “Image”, “HTML” and the like.

As an example herein, “Image” is selected so that image data alone among the contents being displayed is arranged in order and displayed.

### 6. The Sixth Embodiment

Next, the sixth embodiment will be described. The sixth embodiment is an embodiment in which in addition to the fifth embodiment, contents are arranged in order based on the attribute the user has added. That is, in this configuration, contents were once selected based on an inherent attribute and then orderly arranged also by use of the attribute the user has added.

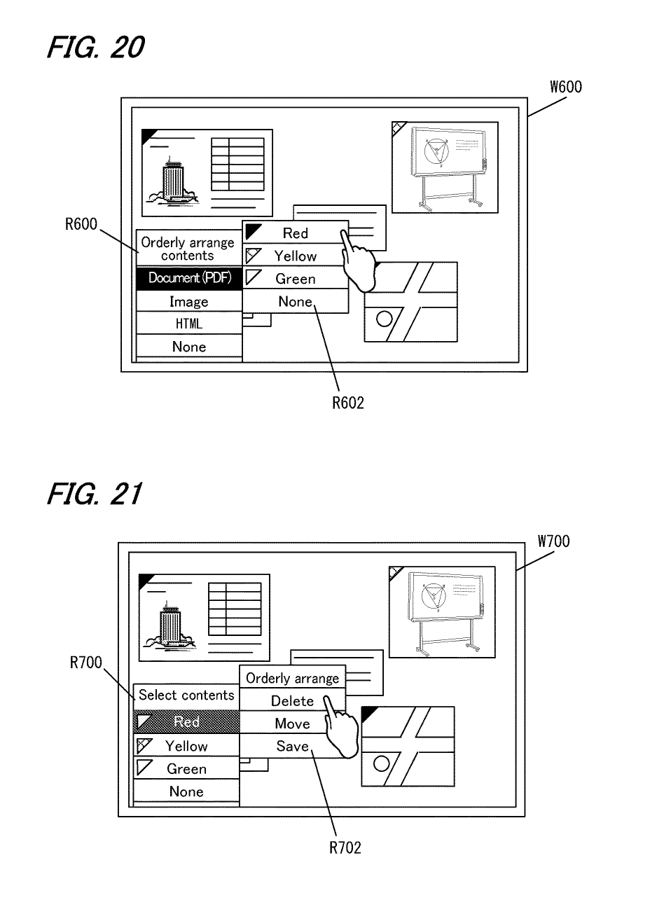

That is, this embodiment is a combination of the first embodiment and the fifth embodiment. The operation example of the present embodiment will be described with reference to FIG. 20. As shown in a display screen W600 of FIG. 20, a parent menu R600 for allowing selection of an inherent attribute is being displayed. As the item “Document (PDF)” is selected in the parent menu R600, a child menu R602 is displayed. The child menu displays the attributes the user has added. From this child menu, one or a plurality of attributes are selected so that the contents having the selected attributes in addition to the inherent attribute are arranged in order. This embodiment is effective when, for example the important document contents alone need to be arranged in order and displayed. Here, it is also possible to display the attribute menu (R602) the user has added first and then display the menu (R600) for selection of an inherent attribute.

### 7. The Seventh Embodiment

Next, the seventh embodiment will be described. The seventh embodiment is an embodiment in which an operation of selected contents can be performed instead of arranging the contents in order.

That is, though the above-described embodiments were all described by giving the cases where contents are arranged in order and displayed, this embodiment enables the user to delete, move and perform other control of contents.

For example, as shown in a display screen W700 of FIG. 21, a menu R702 is displayed as a child menu after displaying a parent menu R700. By selecting “Delete” or other control in the menu R702, it is possible to perform the operation selected from the child menu on the contents of the selected attribute, collectively.

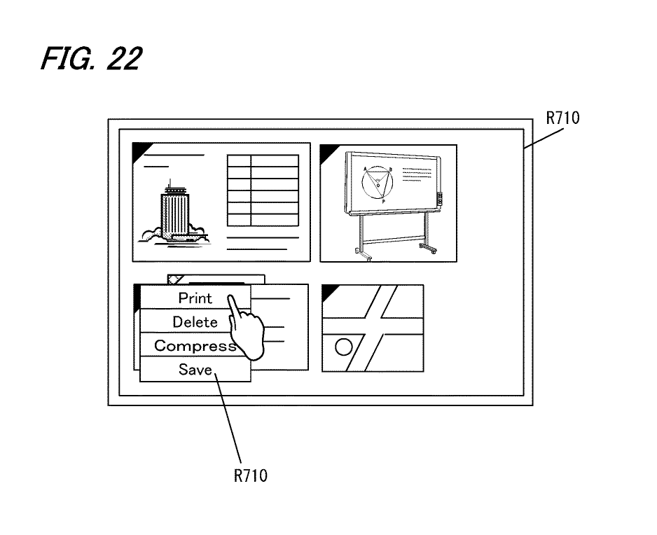

Further, a touch after orderly arranged display of contents causes a menu R710 to appear, as shown in a display screen 710 of FIG. 22. At this stage, when a processing item such as “Print”, “Delete”, “Compress” or “Save”, is selected, it is possible to perform the selected operation on the contents of the selected attribute, collectively.

### 8. The Eighth Embodiment

Next, the eighth embodiment will be described. The eighth embodiment is an embodiment in which layout information based on which contents are laid out when contents are arranged in order, has been stored beforehand, and contents are arranged in order and displayed based on this layout.

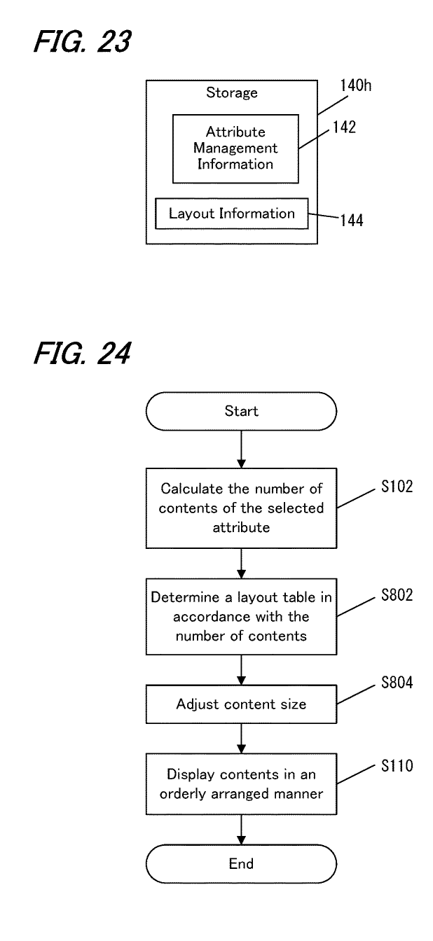

Herein, this embodiment has a configuration where the storage 140 of the first embodiment is replaced by a storage 140h of FIG. 23, and the other functional configurations are the same as in the first embodiment. Further, this embodiment uses a processing flow shown in FIG. 24 instead of the processing flow of FIG. 5. Accordingly, the same steps as those in the processing flow of FIG. 5 are allotted with the same reference numerals and description of them is omitted.

The storage 140h (FIG. 23) stores layout information 144 in addition to attribute management information 142. Stored in the layout information 144 are the number of contents to be displayed and a layout table showing the layout on the display screen. For example, the layout table stores the areas (frames) to be displayed in accordance with the number of contents to be displayed, such that one area if one content is displayed, two areas of 1 (vertical)×2 (horizontal) if two contents are displayed, four areas of 2 (vertical)×2 (horizontal) if three or four contents are displayed.

The process of the present embodiment will be described with reference to FIG. 24. The number of contents of the selected attribute is calculated (Step S102), and the layout table (areas) is determined in accordance with the number of the contents (Step S802).

Then, after determination of the layout frames (areas) to which contents will be arranged, each content is adjusted to the maximum size that can be accommodated in the layout frame (Step S804). Herein, various methods can be considered to arrange the contents. For example, if a margin appears in the layout frame, the content maybe positioned to be adjusted to the top, or be arranged to the right, left or center. Further, the margin may be displayed with the background color (e.g., gray).

When a content is displayed, it is preferable that the aspect ratio is maintained. However, the aspect ratio may be altered by settings so that the content can be displayed maximum. Alternatively, it is possible to select such an arrangement that part of the content can be displayed (for example, part of the content may be displayed in accordance with the layout frame).

In the above way, according to the present embodiment, preparation of a layout table makes it possible to display contents in an arbitrary condition. For example, it is possible to provide a highly flexible layout, by for example, making the layout frame circular, or by displaying contents kept away from regularly displayed contents.

Further, though in the present embodiment the layout table is determined in accordance with the calculated number of contents, the layout table may be determined depending on the types of contents. For example, it is possible to prepare such a layout that contents of document files may be displayed in a greater size than other types of contents, whereas contents of image files maybe displayed in a smaller size (so that a greater number of images may be displayed) other than other types of contents.

Further, each layout frame may be related with a type of a content. For example, it is possible to realize such a combined layout that document files are displayed on the upper side and image files are displayed on the lower side of the display unit 130.

### 9. Variational Examples

As the embodiments of this invention have been detailed with reference to the drawings, the specific configuration should not be limited to these embodiments. Designs and others that do not depart from the gist of this invention should also be included in the scope of claims.

Also, it goes without saying that the present invention can be achieved by combination of the above embodiments. For example, combination of the second embodiment with the third embodiment makes it possible to perform special display of special contents and orderly arranged display of contents of the selected attribute with minimized display of the other contents.

The program to be operated in each device of the embodiment may be a program (program that makes a computer function) for controlling a CPU or the like so as to realize the functions of the embodiments described above. The information to be handled in these devices is temporarily stored in temporary memory device (e.g., RAM) at the time of processing, then is stored into storages such as various kinds of ROM and/or HDDs, and is read out, modified and written in by the CPU, as necessary.

Herein, the recording medium for storing the program maybe any of semiconductor mediums (e.g., ROM, non-volatile memory card, etc.), optical recording mediums/magneto optical mediums (e.g., DVD (Digital Versatile Disc), MO (Magneto Optical Disc), MD (Mini Disc), CD (Compact Disc), BD (Blu-ray Disc) and the like), magnetic recording mediums (e.g., magnetic tape, flexible disc, etc.), and the like. Further, the functions of the above-described embodiments are not only realized by executing the loaded program, but the functions of the present invention may also be realized in accordance with the instructions of the program being executed in cooperation with an operating system, another application program or the like.

To put the product on the market, the program may be stored on a removable storing medium to be put on the market, or may be transferred to a server computer by way of a network such as the Internet or the like. In this case, it goes without saying that the storage device of the server computer is also included in the present invention.

Further, the whole or part of each device in the above-described embodiments may also be typically realized by an LSI (Large Scale Integration) as an integrated circuit. The functional block of each device may be given individually in the form of a chip, or the whole or part may be integrated into a chip. The method of circuit integration may be realized in the form of a dedicated circuit or general purpose processing unit, not limited to LSI. It goes without saying that if a technology of circuit integration replacing LSI technologies appears with the progress of semiconductor technologies, the integrated circuit based on that technology can also be used.

### DESCRIPTION OF REFERENCE NUMERALS

10: display device

110: control unit

120: operation detecting unit

130: display unit

140: storage

142: attribute management information

What is claimed is:

1. A content display device comprising:
a display unit;
a display control unit configured to perform a control of displaying a plurality of contents on the display unit;
a content selecting unit configured to select at least one content from the plurality of contents being displayed;
an attribute determining unit configured to determine an attribute of the selected content; and,
an attribute managing unit configured to manage the determined attribute in association with the selected content, wherein
the display control unit performs a control of displaying the contents that have been displayed on the display unit, in an orderly arranged manner, based on the attribute associated with the content selected by the content selecting unit.

2. The content display device according to claim 1, wherein the display control unit displays distinctively the attribute determined by the attribute determining unit, to the selected content.

3. The content display device according to claim 1, wherein the display control unit performs a minimized display of the content that does not possess the attribute.

4. The content display device according to claim 1, wherein, among the contents possessing the attribute, the display control unit displays the content that possesses one attribute in a first area and displays the content that does not possess the one attribute in a second area.

5. A content display device comprising:
a display unit configured to be able to display a plurality of contents as individual windows;
an attribute selecting unit configured to select a content attribute;
a content selecting unit configured to select a content possessing the selected attribute, from the plurality of contents being displayed; and,
a content orderly arranging unit configured to perform a control of orderly arranging the windows of the selected contents so as to be displayed in parallel.

6. A content display device capable of displaying a plurality of contents on a display unit, comprising:
a display unit configured to display a plurality of contents;
a content selecting unit configured to select one or a plurality of contents from the plurality of contents being displayed;
an attribute determining unit configured to determine an attribute of the selected content;
an attribute managing unit configured to manage the determined attribute in association with the selected content; and,
a processing unit configured so that when one attribute is selected from a plurality of attributes set by the attribute determining unit beforehand, a predetermined process is executed on the contents having the selected attribute.

7. A program executed in a computer configured to be able to display a plurality of contents on a display unit, realizing:
a content selecting function of selecting one or a plurality of contents from a plurality of contents being displayed on the display unit;
an attribute determining function of determining an attribute of the selected content;
an attribute management function of managing the determined attribute in association with the selected content;
an attribute selecting function of selecting one attribute from a plurality of attributes determined by the attribute determining function; and,
a display function of displaying contents of the attribute selected by the attribute selecting function in an orderly arranged manner.
